(19) United States
(12) Patent Application Publication
(10) Pub. No.: US 2020/0158516 A1
(43) Pub. Date: May 21, 2020

(54) METHOD AND APPARATUS FOR DETERMINING MAP MATCHING QUALITY USING BINARY CLASSIFICATION

(71) Applicant: HERE GLOBAL B.V., Eindhoven (NL)

(72) Inventors: William GALE, Oak Park, IL (US); Bishnu PHUYAL, Mount Prospect, IL (US); Ian ENDRES, Naperville, IL (US)

(21) Appl. No.: 16/196,945

(22) Filed: Nov. 20, 2018

(51) Int. Cl. G01C 21/32

(52) U.S. Cl. CPC G01C 21/32

(57) ABSTRACT

An approach is provided for determining map matching quality using binary classification. The approach, for example, involves processing probe trajectory data using a map matcher to generate a map-matched output. The approach also involves comparing the map-matched output for a probe point of the probe trajectory data against ground truth map-matched data for the probe trajectory data to classify the probe point according to one or more binary classifications. The one or more binary classifications indicate a correctness or an incorrectness of matching with respect to the ground truth map-matched data. The approach further involves computing the map matching quality of the map matcher based on the one or more binary classifications.

### BACKGROUND

Map-matching systems (i.e., map-matchers) have traditionally been used to process probe trajectory data (e.g., Global Positioning Satellite (GPS) probe points) representing vehicle travel along a road network to match the probe points to road links of a digital map. Correctly placing probe points to road links of a map segment is of great importance to mapping and navigation services (e.g., for route guidance purposes, traffic monitoring, etc.). As a result, a large number of map-matchers have been developed using a variety of different map matching techniques and algorithms. This variety, however, also makes evaluating the performance of available map-matchers technically challenging to ensure, for instance, that the performance evaluation does not favor or disadvantage a process used by a particular map-matcher.

### SOME EXAMPLE EMBODIMENTS

Therefore, there is a need for map matching evaluation framework that can be used to evaluate and compare the performance of different map-matchers.

According to one embodiment, a computer-implemented method for determining map matching quality comprises processing probe trajectory data using a map matcher to generate a map-matched output. The method also comprises comparing the map-matched output for a probe point of the probe trajectory data against ground truth map-matched data for the probe trajectory data to classify the probe point according to one or more binary classifications. The one or more binary classifications indicate a correctness or an incorrectness of matching with respect to the ground truth map-matched data. The method further comprises computing the map matching quality of the map matcher based on the one or more binary classifications.

According to another embodiment, an apparatus for determining map matching quality comprises at least one processor, and at least one memory including computer program code for one or more computer programs, the at least one memory and the computer program code configured to, with the at least one processor, cause, at least in part, the apparatus to process probe trajectory data using a map matcher to generate a map-matched output. The apparatus is also caused to compare the map-matched output for a probe point of the probe trajectory data against ground truth map-matched data for the probe trajectory data to classify the probe point according to one or more binary classifications. The one or more binary classifications indicate a correctness or an incorrectness of matching with respect to the ground truth map-matched data. The apparatus is further caused to compute the map matching quality of the map matcher based on the one or more binary classifications.

According to another embodiment, a computer-readable storage medium for determining map matching quality carries one or more sequences of one or more instructions which, when executed by one or more processors, cause, at least in part, an apparatus to process probe trajectory data using a map matcher to generate a map-matched output. The apparatus is also caused to compare the map-matched output for a probe point of the probe trajectory data against ground truth map-matched data for the probe trajectory data to classify the probe point according to one or more binary classifications. The one or more binary classifications indicate a correctness or an incorrectness of matching with respect to the ground truth map-matched data. The apparatus is further caused to compute the map matching quality of the map matcher based on the one or more binary classifications.

According to another embodiment, an apparatus for determining map matching quality comprises means for processing probe trajectory data using a map matcher to generate a map-matched output. The apparatus also comprises means for comparing the map-matched output for a probe point of the probe trajectory data against ground truth map-matched data for the probe trajectory data to classify the probe point according to one or more binary classifications. The one or more binary classifications indicate a correctness or an incorrectness of matching with respect to the ground truth map-matched data. The apparatus further comprises means for computing the map matching quality of the map matcher based on the one or more binary classifications.

According to one embodiment, a computer-implemented method for determining map matching quality comprises collecting probe trajectory data from a plurality of sensors covering a plurality of road types. The method also comprises using a reference map matcher to generate a candidate map-matched output, wherein the candidate map-matched output is verified to create ground truth map-matched data for the probe trajectory data. The map matching quality of a map matcher is then determined by using the map matcher to generate a map-matched output from the probe trajectory and computing the map matching quality based on one or more binary classifications of a comparison of the map-matched output and the ground truth map-matched data.

According to another embodiment, an apparatus for determining map matching quality comprises at least one processor, and at least one memory including computer program code for one or more computer programs, the at least one memory and the computer program code configured to, with the at least one processor, cause, at least in part, the apparatus to collect probe trajectory data from a plurality of sensors covering a plurality of road types. The apparatus is also caused to use a reference map matcher to generate a candidate map-matched output, wherein the candidate map-matched output is verified to create ground truth map-matched data for the probe trajectory data. The map matching quality of a map matcher is then determined by using the map matcher to generate a map-matched output from the probe trajectory and computing the map matching quality based on one or more binary classifications of a comparison of the map-matched output and the ground truth map-matched data.

According to another embodiment, a computer-readable storage medium for determining map matching quality carries one or more sequences of one or more instructions which, when executed by one or more processors, cause, at least in part, an apparatus to collect probe trajectory data from a plurality of sensors covering a plurality of road types. The apparatus is also caused to use a reference map matcher to generate a candidate map-matched output, wherein the candidate map-matched output is verified to create ground truth map-matched data for the probe trajectory data. The map matching quality of a map matcher is then determined by using the map matcher to generate a map-matched output from the probe trajectory and computing the map matching quality based on one or more binary classifications of a comparison of the map-matched output and the ground truth map-matched data.

According to another embodiment, an apparatus for determining map matching quality comprises means for collecting probe trajectory data from a plurality of sensors covering a plurality of road types. The apparatus also comprises means for using a reference map matcher to generate a candidate map-matched output, wherein the candidate map-matched output is verified to create ground truth map-matched data for the probe trajectory data. The map matching quality of a map matcher is then determined by using the map matcher to generate a map-matched output from the probe trajectory and computing the map matching quality based on one or more binary classifications of a comparison of the map-matched output and the ground truth map-matched data.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of determining map matching quality using binary classification, according to one embodiment;

FIG. 2 is a diagram of the components of a map matching evaluation (MME) platform, according to one embodiment;

FIG. 3 is a flowchart of a process for generating ground truth probe trajectory data for determining map matching quality, according to one embodiment;

FIGS. 4A and 4B are diagrams illustrating an example user interface for verifying map matching results to create ground truth data, according to one embodiment;

FIG. 5 is a diagram of an example data structure for ground truth probe trajectory data, according to one embodiment;

FIG. 6 is a flowchart of a process for determining map matching quality using binary classification, according to one embodiment;

FIG. 7 is a diagram of an example map-matched output appended with binary classifications, according to one embodiment;

FIG. 8 is a diagram illustrating an example user interface for presenting map matching quality results, according to one embodiment;

FIG. 9 is a diagram of a geographic database, according to one embodiment;

FIG. 10 is a diagram of hardware that can be used to implement an embodiment;

FIG. 11 is a diagram of a chip set that can be used to implement an embodiment; and

FIG. 12 is a diagram of a mobile terminal (e.g., handset or vehicle or part thereof) that can be used to implement an embodiment.

### DESCRIPTION OF SOME EMBODIMENTS

Examples of a method, apparatus, and computer program for determining map matching quality using binary classification, according to one embodiment, are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

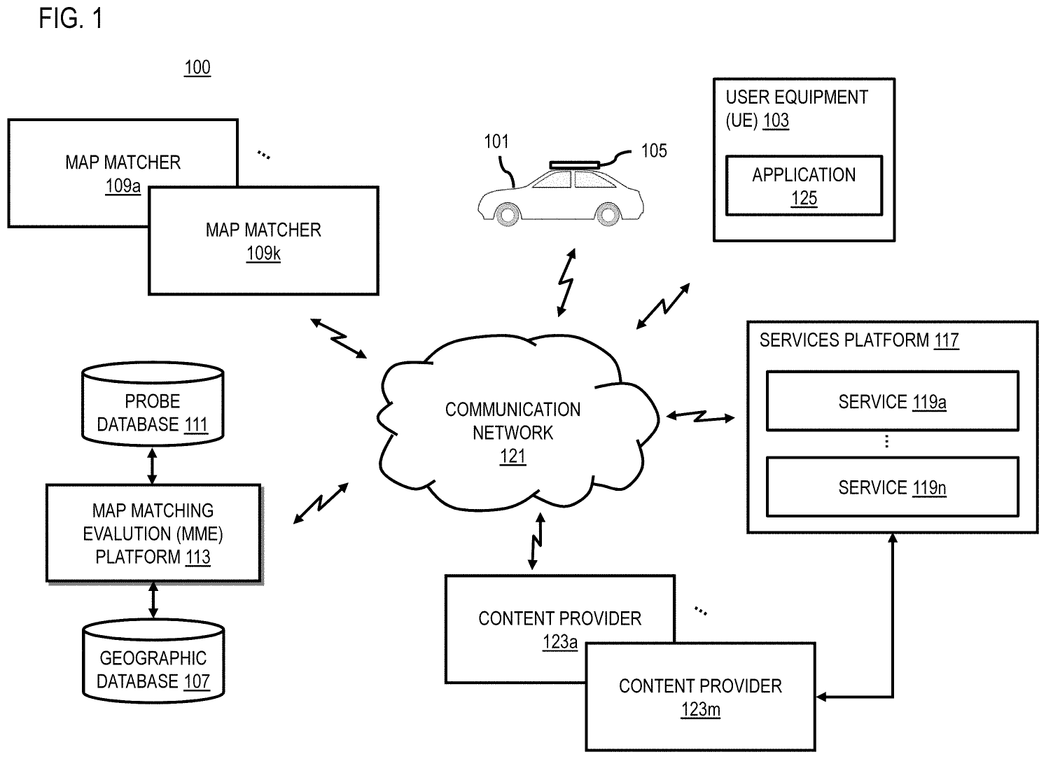

FIG. 1 is a diagram of a system capable of determining map matching quality using binary classification, according to one embodiment. As noted above, correctly placing probe points of a probe trajectory on a map segment can of great importance to mapping and/or navigation service providers and their customers. For example, a probe (e.g., a vehicle 101 and/or user equipment (UE) 103 such as smartphone or other mobile device) can be configured to collect location samples (e.g., probe points comprising the probe's location <latitude, longitude, elevation> and heading) using onboard sensors 105 at a designated frequency. This time-ordered sequence of probe points makes up the probe's trajectory. For example, correctly placing these probe points or probe trajectories to a map or road segment (e.g., segment represented in a digital map such as a geographic database 107) can provide information on traffic on a road section or enable accessing other information about the matched segment. The process for placing probe points or trajectories onto a road links of a digital map is called map matching. In other words, map matching associates a probe point with a road segment on a map. Getting correct road segment (link) information is possible only if the probe point is correctly associated with the road segment (link).

Historically, developers use different methods and algorithms for creating a map matching application or system (e.g., map matchers 109a-109k, also collectively referred to as map matchers 109). These different methods and algorithms represent an individual best estimation of what will produce correct map matching results as often as possible. For example, correctly associating a probe point with a map road link depends on factors such as the following:
(1) Inherent uncertainty in the abstraction of road networks by links to form database geometry;
(2) Inaccurate representation of a road's geometry;
(3) Uncertainty in probe position; and
(4) Robustness of map matching method and parameters thresholds.

Given a set of probe data and a map database, the quality of the map matching therefore depends upon the method, algorithm and parameters as the probe data quality and map remains the same for all map matchers 109. As different map matchers 109 use different thresholds parameters in different ways, the results obtained will therefore not be the same. Some results will be more accurate than the others. It is essential to know the quality of a map matcher 109 for three important reasons:
(1) Know where and why the results are found incorrect;
(2) Implement modifications or apply new methods and algorithms for improvement; and
(3) Comparison with other map matchers 109 to choose the best map matcher 109.

Map matching developers generally devise their own method to evaluate the performance of their map matcher 109. However, these evaluation methods are typically tailored to suit the need and the system used for the map matcher 109. As a result, such system specific methods may not be suitable or used by other map matchers 109, and hence have limited scope. In other words, other developers may or may not be able adopt and apply a given evaluation method devised by another developer to evaluate their map matcher 109. This is because there is no single systematic and comprehensive method that can be used to evaluate the quality of any map matcher. In the absence of a method to measure the quality of any map matcher, it will not be simple to judge the relative strength and weakness of different map matchers and select the one most reliable. Therefore, there are technical challenges associated with as well as a need for developing a common evaluation system that can be used by multiple map matchers 109.

To address these technical challenges, the system 100 of FIG. 1 introduces a capability to evaluate the accuracy of any map matcher 109 using a set of probe data (e.g., probe trajectory data of a probe database 111) and ground truth data to determine the quality or performance of map matchers 109 using extended binary classifications. In one embodiment, the system 100 provides a map matching evaluation framework (MMEF) including a map matching evaluation (MME) platform 113 that determines various statistical quantities based on extended binary classification of map matching results. These statistical quantities express various facades of map matching quality for each evaluated map matcher 109. In one embodiment, the map matchers 109 can then be compared and ranked using these statistical quantities for presentation to end users who are selecting from among the various map matchers 109.

In one embodiment, the MMEF can be used to evaluate the quality of any map matcher performance. The statistical results obtained from using the MMEF from multiple map matchers 109 allow they system 100 to compare and rank map matchers 109 for their strengths and weaknesses. In one embodiment, this is achieved with all or any subset of the following steps:
(1) Standard format for input and output data: MMEF defines and adapts a common probe data input format and common output results format. In this way, the MMEF software developed for this purpose can be applied to any map matcher.
(2) Ground truth: Creation of ground truth data consisting of database LinkID (e.g., specified from the geographic database 107) for each input probe point from a number of drives. Any probe point not driven on a road section is assigned null. The ground truth data and map matching results obtained from individual map matchers are compared.
(3) Definition of extended binary classification (EBC): EBC in map matching provides binary classifications indicating the correctness or incorrectness of map-matched results against the ground truth data. Extended, for instance, refers to creating additional binary classifications because the correctness or incorrectness can be characterized with respect to a probe point being matched or unmatched as well as whether a matched LinkID matches the link information of the ground truth data.
(4) Process and derive EBC statistics: Uses EBC to aggregate statistic elements across the different classifications.
(5) Elements of map matching quality: Derive accuracy, precision, recall, F1 score, and/or the like based on aggregated statistical elements.
(6) Ranking map matchers: Use accuracy, precision, recall, and F1 score statistics obtained from the evaluation and comparison to rank map matchers.

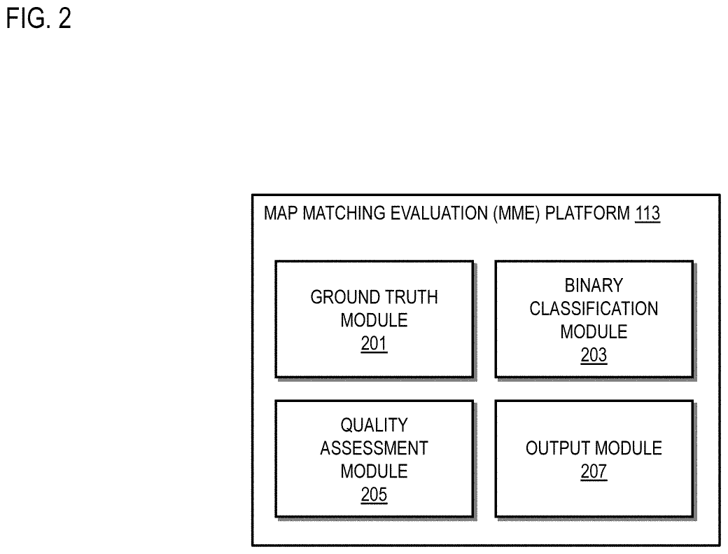

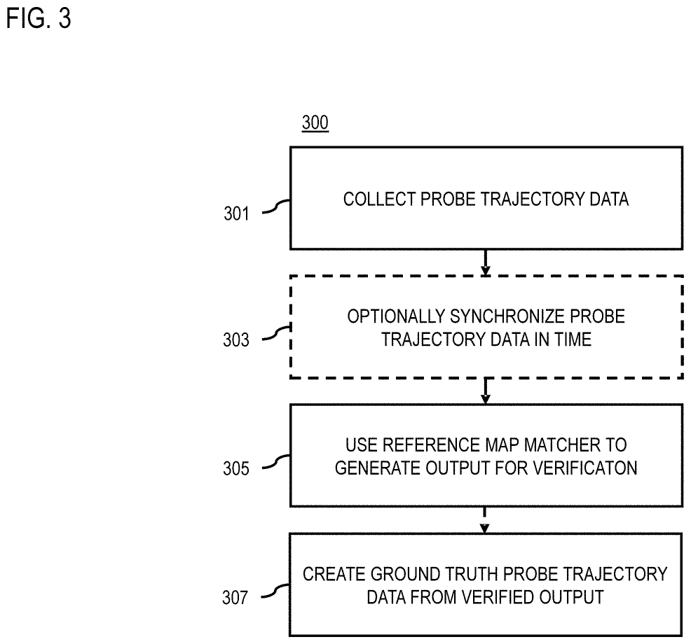

In one embodiment, as shown in FIG. 2, the MME platform 113 includes one or more components for determining map matching quality using binary classification, according to the various embodiments described herein. It is contemplated that the functions of these components may be combined or performed by other components of equivalent functionality. In this embodiment, the MME platform 113 includes a ground truth module 201, binary classification module 203, quality assessment module 205, and output module 207. The above presented modules and components of the MME platform 113 can be implemented in hardware, firmware, software, or a combination thereof. Although shown as a separate entity in FIG. 1, it is contemplated that the MME platform 113 may be implemented as a module of any other component of the system 100 (e.g., a component of the services platform 117, services 119a-119n (also collectively referred to as services 119), vehicle 101, UE 103, etc.). In another embodiment, one or more of the modules 201-207 may be implemented as a cloud based service, local service, native application, or combination thereof. The functions of the MME platform 113 and the modules 201-207 are discussed with respect to FIGS. 3-8 below.

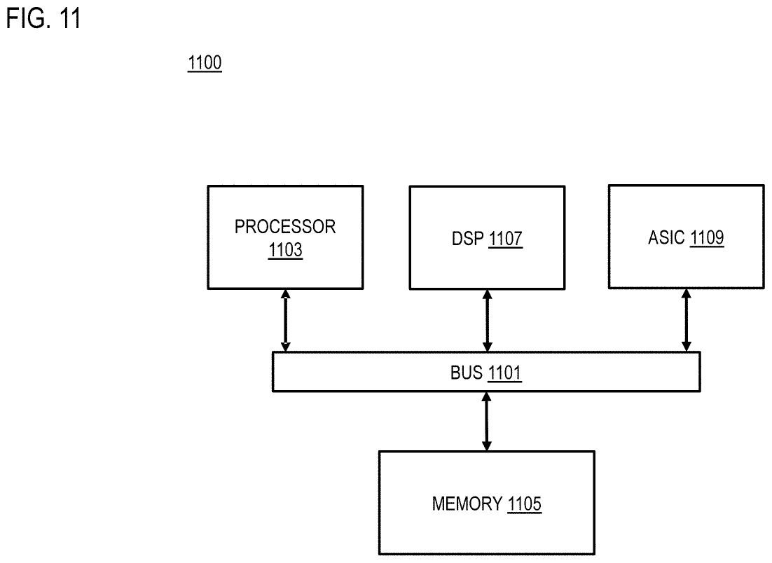

FIG. 3 is a flowchart of a process for generating ground truth probe trajectory data for determining map matching quality, according to one embodiment. In various embodiments, the MME platform 113 and/or any of the modules 201-207 may perform one or more portions of the process 300 and may be implemented in, for instance, a chip set including a processor and a memory as shown in FIG. 11. As such, the MME platform 113 and/or any of the modules 201-207 can provide means for accomplishing various parts of the process 300, as well as means for accomplishing embodiments of other processes described herein in conjunction with other components of the system 100. Although the process 300 is illustrated and described as a sequence of steps, its contemplated that various embodiments of the process 300 may be performed in any order or combination and need not include all of the illustrated steps.

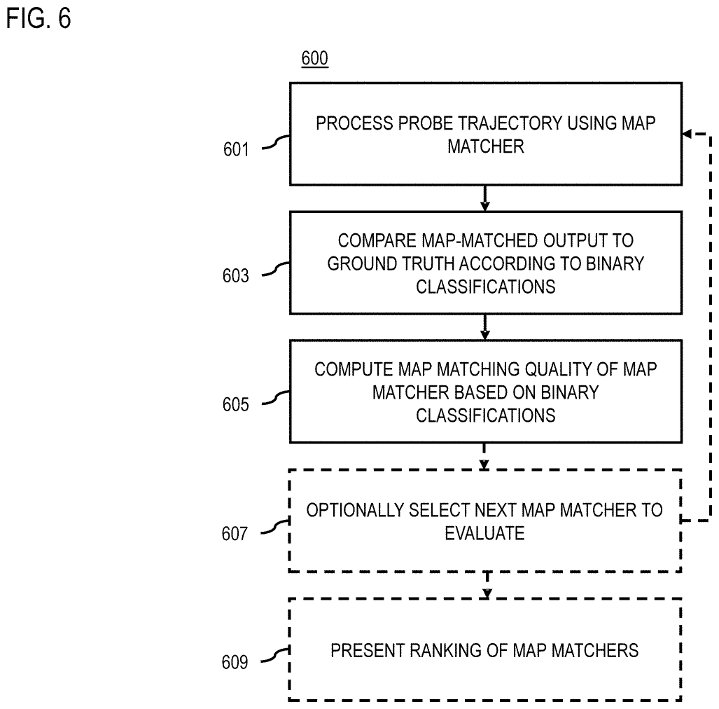

In one embodiment, the determining of map matching quality depends on the use of ground truth probe trajectory data includes probe data that is accompanied a set of ground truth values that the MME platform 113 considers to an accurate or true map matching result. For example, the MME platform 113 can use the ground truth data to determine whether a probe point that is matched by a map matcher 109 is accurate in relation of the ground truth data. The correctness or incorrectness of the match with respect to the ground truth data can then be used to determine the EBC classifications for each probe (e.g., described in more detail with respect to the process 600 of FIG. 6 below). It is contemplated that the MME platform 113 can obtain ground truth probe trajectory data using any means including but not limited to the process 300 of FIG. 3. In other words, the process 300 is provided by way of illustration and is not intended as a limitation.

In one embodiment, the process 300 provides for a semi-automated ground truth creation process that can be performed as needed to create or update the ground truth trajectory data used for map matcher evaluation. For example, the process 300 can be performed once when the MMEF or MME platform 113 is initialized to performed evaluations.

In step 301, the ground truth module 201 obtains or retrieves probe trajectory data collected from sensors (e.g., sensor 105) of probes (e.g., vehicles 101 and/or UEs 103) traveling in a road network. In one embodiment, the probe trajectory data can include sets of probe trajectories (e.g., GPS trajectories) from multiple sensors 105 covering various types of roads (e.g. freeways, arterials, ramps, gridded area, off roads, etc.) to improve the statistical validity of the ground truth data. In one embodiment, the trajectory data can be collected from the different road types simultaneously or substantially simultaneously (e.g., collected within a designated time window within a time threshold of each other). Input data are organized in a defined format, and all probe points are tagged with a time value at the collection time.

If the co-collected probe trajectories do not use one standard time system, the ground truth module 201 can optionally synchronize the co-collected probe data in time before creating Ground Truth (optional step 303). For example, one set of probe data (e.g., collected from specialized mapping vehicles) may be found using GPS system time, other sensors used to collect other probe data sets may have used atomic time, UTC time, and/or any other time system. The differences in time between these time systems can then be determined and applied for the synchronization. In one embodiment, the results of the time offsets can also be independently verified by aligning positional data between the different sensors in terms of their closeness in overlapping positions of their respective datasets.

In step 305, the ground truth module 201 can then select a reference map matcher (e.g., any map matcher 109 designated by the MME platform 113) to obtain map matching results of the input probe data in a defined output format. These results can be considered as candidate map matching results or candidate map matched output that can be used to generate the final ground truth probe trajectory data. In one embodiment, the ground truth module 201 can then verify the candidate map matching results to create ground truth data (step 307).

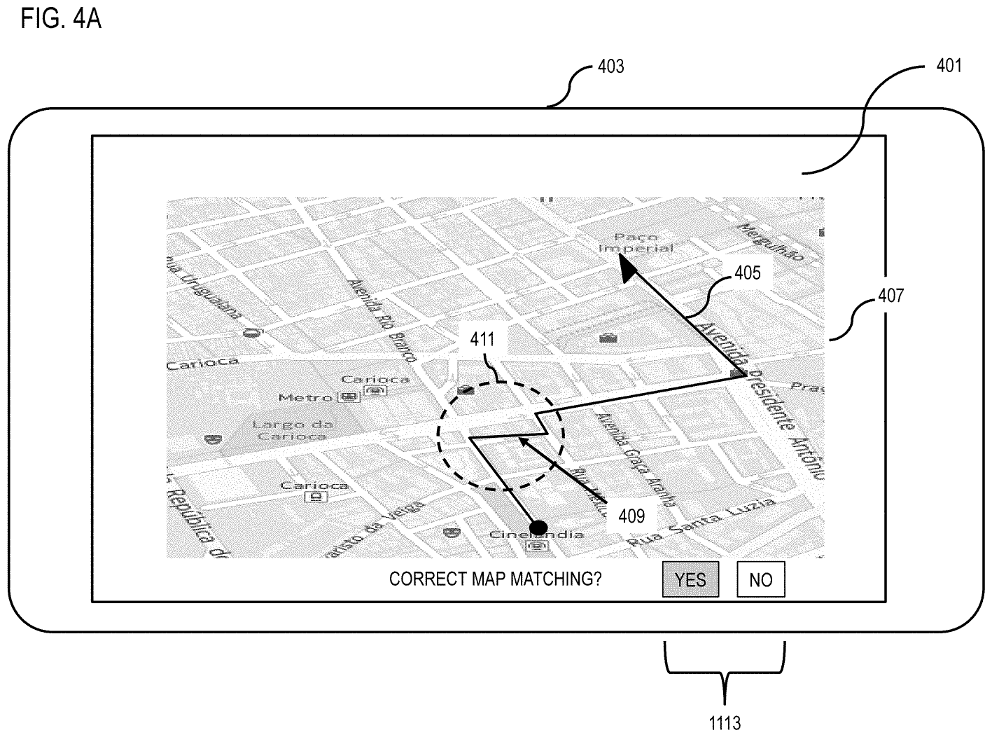

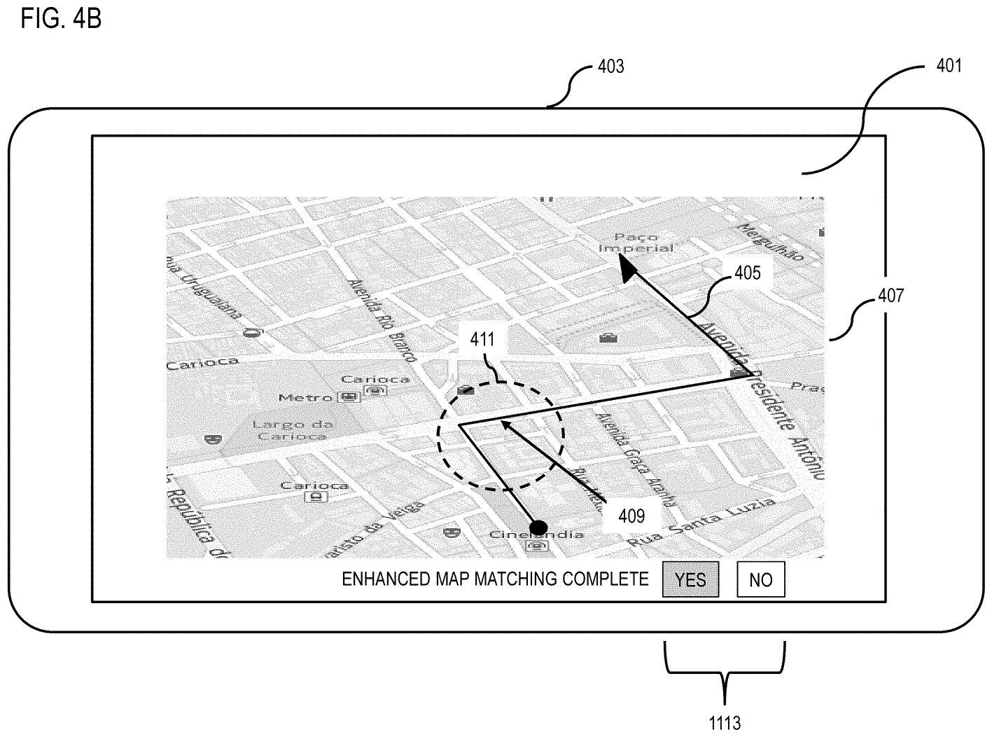

In one embodiment, the verification process can be a manual process to verify the map matchers Link ID with the actual Link ID driven. In one embodiment, the ground truth module 201 can interact with the output module 207 to present a user interface that overlays the map matcher result data on a map and enabling a user to checking candidate map matching results (e.g., the matched LinkID) for each probe point on the map. FIGS. 4A and 4B are diagrams illustrating an example user interface for verifying map matching results to create ground truth data, according to one embodiment. In the example of FIG. 4A, the output module 207 presents a map user interface 401 on a device 403 (e.g., a client terminal such as a computer or equivalent device) displaying a probe trajectory 405 as an overlay on a map segment 407 to which the reference map matcher has matched the trajectory 405. A user can then select individual probe points or trajectory segments to verify or correct. In this example, the user has selected trajectory segment 409 in the map area 411 to verify and correct. This selection is confirmed by the presentation of a message and options 413 asking the user whether the user would like to correct the map matching for the trajectory segment 409. FIG. 4B illustrates the results of the verification and correction of FIG. 4A. As shown in FIG. 4B, the trajectory segment 409 has been corrected so that it is matched to a different road link or segment than in the example of FIG. 4A. The verification process can be repeated or performed for each trajectory in the collected set of probe trajectories.

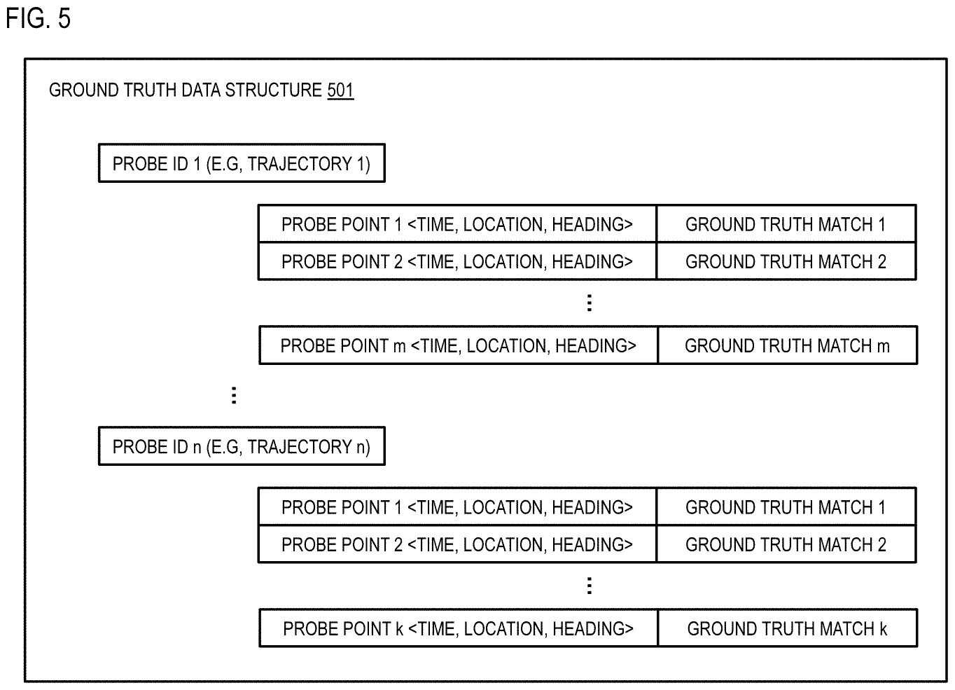

In one embodiment, after verification of the candidate map matching results, the ground truth module 201 uses the verified candidate map matching results to create ground truth probe trajectory data. In one embodiment, the ground truth probe trajectory data can be created as a file (e.g., a ground truth data file) according to a standard format as shown in FIG. 5. In the example of FIG. 5, a ground truth data structure 501 includes one or trajectories 1 to n (e.g., corresponding respectively to probe IDs 1 to n), with each trajectory including a set of probe points (e.g., comprising a time of collection, location <latitude, longitude, elevation>, and heading) with a corresponding ground truth match result. In one embodiment, the ground truth match result field can be populated with the matched ground truth LinkID or another matched road segment identifier. If there is no match (e.g., does not match any road link in the digital map), the field can be left blank. If the map matcher cannot make a determination of whether a probe point is matched or unmatched (e.g., if matching/unmatching criteria such as matching confidence is not met) or the result cannot be verified, then the ground truth match data filed can be populated with a value indicating that the match is unknown. It is noted that the data structure 501 is provided by way of illustration and not as a limitation. Accordingly, any equivalent data structure can be used according to the embodiments described herein. In one embodiment, the ground truth probe trajectory data generated according to the embodiments described above or otherwise obtained can then be used for determining map quality as described with respect to FIG. 6 below.

FIG. 6 is a flowchart of a process for determining map matching quality using binary classification, according to one embodiment. In various embodiments, the MME platform 113 and/or any of the modules 201-207 may perform one or more portions of the process 600 and may be implemented in, for instance, a chip set including a processor and a memory as shown in FIG. 11. As such, the MME platform 113 and/or any of the modules 201-207 can provide means for accomplishing various parts of the process 600, as well as means for accomplishing embodiments of other processes described herein in conjunction with other components of the system 100. Although the process 600 is illustrated and described as a sequence of steps, its contemplated that various embodiments of the process 600 may be performed in any order or combination and need not include all of the illustrated steps.

As previously described, in one embodiment, the MME platform 113 uses binary classification (e.g., extended binary classification) to determine map matching quality for map matchers 109 being evaluated. To initiate the process 600, in step 601, the binary classification module 203 processes probe trajectory data (e.g., the ground truth probe trajectory generated as described above) using a map matcher 109 (e.g., a map matcher 109 selected for evaluation) to generate a map-matched output. In one embodiment, the binary classification module 203 takes the map matched output file generated by the evaluated map matcher 109 and append columns for the binary classifications that will be used to evaluate the quality of the map-matched output. These binary classifications are described in more detail below.

In general, map matchers 109 can be considered as a classifier which can have two outcomes (e.g., binary outcomes)—a probe point can be matched (M) or unmatched (U). The ground truth serves to establish the actual outcome. Thus, for a given observation the classified result can be Correct (C) or Incorrect (I). To employ binary classification, these observations and outcomes are mapped into True Positive (TP), True Negative (TN), False Positive (FP), False Negative (FN) cases as shown in Table 1 below:

TABLE 1

| | C | I |
|---|---|---|
| M | TP | FP |
| U | TN | FN |

In one embodiment, the MME platform 113 extends this binary classification method, since each matchable probe point must also correctly identify the link ID or road segment to which it is mapped, hence the Extended Binary Classification (EBC). With this EBC, there are six different possible EBC elements defined as shown in Table 2 below. For each probe point, possible outcomes for these parameters are binary values of 0 indicating that the classification does not apply to the probe point or 1 indicating that classification does apply. In one embodiment, only one binary classification among the six will be 1 and the rest are all 0.

TABLE 2

| Term | Case | Description |
|---|---|---|
| 1 MC | Matched | Probe point matched same link ID as the Ground |
| | Correct | Truth |
| 2 MI | Matched | Probe point match incorrectly (either MI1 or MI2, |
| | Incorrect | MI = MI1 + MI2) |
| 2.1 | Matched | Probe point matched to a different link than the |
| MI1 | Incorrect1 | Ground Truth |
| 2.2 | Matched | Probe point matched but Ground Truth is unmatched |
| MI2 | Incorrect2 | |
| 3 UC | Unmatched | Probe point and Ground Truth are unmatched |
| | Correct | |
| 4 UI | Unmatched | Probe point unmatched but Ground Truth is matched |
| | Incorrect | |
| 5 MX | Matched | Probe point matched but Ground Truth is unknown |
| | Unknown | |
| 6 UX | Unmatched | Probe point unmatched but Ground Truth is |
| | Unknown | unknown |

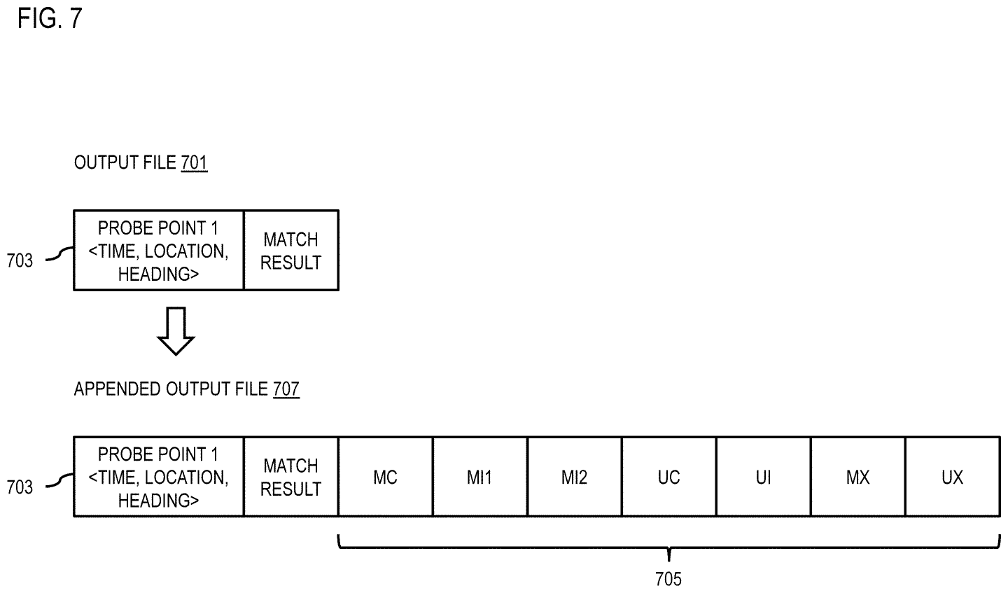

FIG. 7 illustrates an example of appending an output file of the evaluated map matcher 109 to add the binary classifications above. In the example of FIG. 7, the original output file 701 includes a data record 703 including a field for identifying a probe point and a field indicating the map match result of the probe point as determined using the evaluated map matcher 109. In one embodiment, the binary classification module 203 can then append additional data fields 705 to the data record 703 corresponding to the seven binary classifications described above to create an appended output file 707. The process can be repeated for each probe point data record in the map matched output file of the evaluated map matcher 109.

To populate the values of the appended EBC data fields, in step 603, the binary classification module 203 compares the map-matched output for a probe point of the probe trajectory data against ground truth map-matched data for the probe trajectory data to classify the probe point according to one or more binary classifications. In other words, the binary classification module 203 takes a probe point from the appended map-matched output file and checks its map match result (e.g., matched LinkID determined by the evaluated map matcher 109) with the ground truth map match result (e.g., matched LinkID in the ground truth data file). The comparison includes determining whether the correctness or incorrectness of the map matched result relative to the ground truth data meets any of the EBC classification criteria. For example, the binary classification can evaluate the following criteria to assign a binary value (0 or 1) to the respective EBC category (e.g., MC, MI1, MI2, UC, UI, MX, and UX):
MC: a matched corrected classification indicating that the probe point is matched by the map matcher to a same road link as indicated in the ground truth map-matched data;
MI1: a first matched incorrect classification indicating that the probe point is matched by the map matcher a different road link than indicated in the ground truth map-matched data;
MI2: a second matched incorrect classification indicating that probe point is matched by the map matcher but is not matched in the ground truth map-matched output;
MI: a combined matched incorrect classification that combines the first matched incorrect classification and the second matched incorrect classification;
UC: an unmatched correct classification indicating that probe point is unmatched by the map matcher and in the ground truth map-matched data;
UI: an unmatched incorrect classification indicating that the probe point is unmatched by the map matcher but is matched in the ground truth map-matched data;
MX: a matched unknown classification indicating that the probe point is matched by the map matcher but is unknown in the ground truth map-matched data; and
UX: an unmatched unknown classification indicating that the probe point is unmatched by the map matcher but is unknown in the ground truth map-matched data.

In one embodiment, the binary classification module 203 assigns a binary value of 1 to one EBC among the classifications in the appended probe point data record for the probe points in the output file and sets the remaining EBC data fields to 0. The EBC classifications are thus inserted into the appended map matched output file. This process can be repeated for all of the probe points in the appended output file.

In step 605, the quality assessment module 205 can then compute the map matching quality of the evaluated map matcher 109 based on the one or more binary classifications determined as described above. For example, in one embodiment, the quality assessment module 205 aggregates the binary values of the EBC data fields recorded in the appended output file for each of the EBC classifications. The aggregation, for instance, comprises adding up the number of probe points classified under each of the EBC classifications. In this way, the quality assessment module 205 can derive percentage values for these statistical quantities of each EBC by dividing the number of probe points in the map matched output file.

In one embodiment, the aggregation of the EBC statistical quantities allows the quality assessment module 305 to advantageously calculate accuracy parameters to represent the map matching quality of the evaluated map matcher 109. The accuracy parameters include but are not limited to the following:

$$\begin{matrix}Accuracy \text{:} ACC = \frac{MC + UC}{MC + UC + MI + UI} & ( 1 ) \\ Precision \text{:} P = \frac{MC}{MC + UI} & ( 2 ) \\ Recall \text{:} R = \frac{MC}{MC + MI 1 + UI} & ( 3 ) \\ F 1 score \text{:} f 1 = 2 \frac{P R}{P + R} & ( 4 )\end{matrix}$$

In the above equations above, abbreviations corresponding to EBC classifications refer to the respective statistical quantities generated from the aggregated binary values as described above. In one embodiment, the F1 Score is derived from the calculated accuracy, precision, and recall values and represents the harmonic mean of precision and recall.

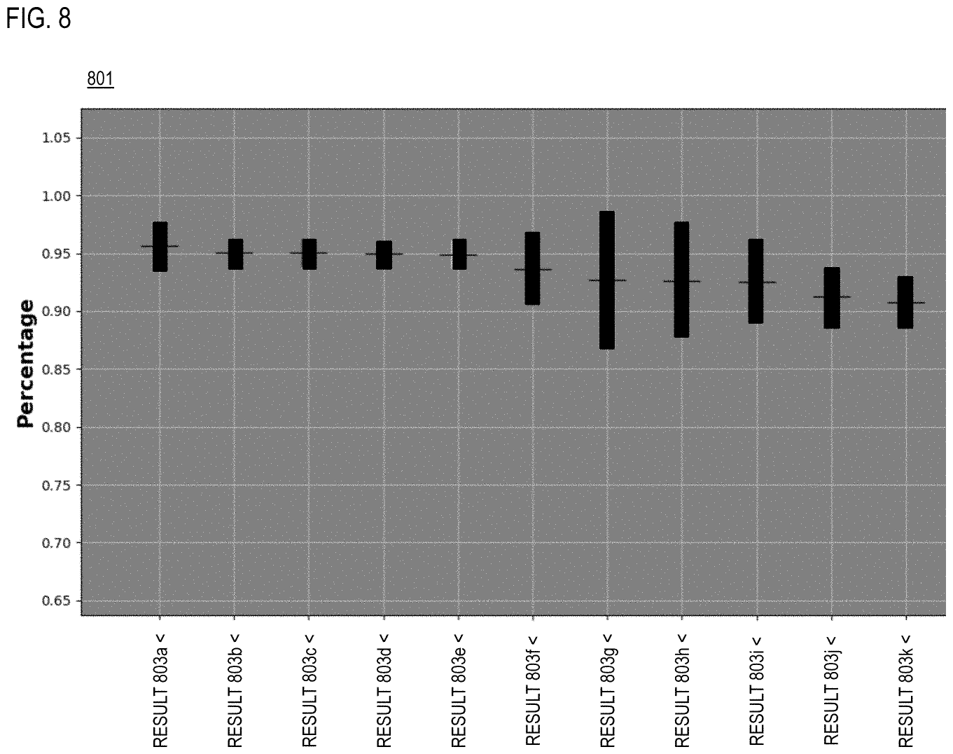

In one embodiment, in step 607, the MME platform 113 can optionally repeat steps 601-605 described above for each map matcher 109 that is be evaluated. In this way, the MME platform 113 provides a common and systematic framework (e.g., MMEF) that can be applied across a variety of different map matchers 109 to determine their respective map matching quality and performance. In one embodiment, the output module 207 can use the results of the map matcher quality evaluations to provide graphical outputs representative the map matching quality for one or all of the map matchers (an example of such a display is illustrated in FIG. 8 and described with respect to an example further below) (step 609).

In one embodiment, the MME platform 113 can also use the map matching quality results to rank all the evaluated map matchers 109. For example, the ranking can be performed in decreasing order of the statistical results (e.g., accuracy, precision, recall, F1 score).

In other embodiments, the MME platform 113 can create subsets of the ground truth trajectory data based on a map attribute, a probe vehicle attribute, a location sensor attribute, or a combination thereof. The map-matched output and corresponding quality can then be determined with respect to the respect to the map attribute, the probe vehicle attribute, the location sensor attribute, or a combination thereof. For example, the ground truth data can be processed to extract probe data corresponding only to ramps road links (e.g., ramp LinkID queried from the geographic database 107). Then the determined map matching quality will be relevant to evaluating the performance of map matchers 109 is matching probe points to ramp road segments (e.g., highway on and off ramps). As other examples, the ground truth probe trajectory data can be segmented based on: (1) map attributes such as but not limited to intersections, high speed roads, bridges, tunnels, etc.; (2) location sensor attributes (e.g., GPS attributes) such as but not limited to vertical accuracy, horizontal accuracy, etc.; and (3) probe vehicle attributes (e.g., vehicle dynamics) such as but not limited to speed, heading, etc.

In one embodiment, the MME platform 113 can also create smaller sets of data by resampling the original ground truth trajectory data based on a time interval (e.g., every 1 sec, 5 sec, 10 sec, 30 sec, 60 sec, 1 m, 5 m, 25 m, 50 m, etc.). The enables the MME platform 113 a number subsets of the ground truth trajectory data and then determine map matching quality for each subset. Use of the these resampled ground truth datasets (along with the original dataset) can be useful for at least the following reasons: (1) it helps to determine the effect of data update rates on the quality of map matchers 109; and (2) the results from these different resample datasets are useful to derive the average quality and standard errors.

FIG. 8 is a diagram illustrating an example user interface 801 for presenting map matching quality results, according to one embodiment. In the example of FIG. 8, the embodiments of the processes for determining map matching quality using binary classification are tested with probe data collected for over a defined time periods (e.g., 11 different days) using sensors from vehicles 101 and UEs 103 traveling in an area of interest. Many different sets of the quality results, as for example results for each data types (e.g., data from vehicles 101 only, data from UEs 103 only, etc.), subset for gridded area, subset for ramps, etc. were obtained for different map matching results (e.g., map matching results 803a-803k). Each result 803a-803k can come from either the same or different map matchers 109 (e.g., 6 different map matchers 109 producing the 11 map matching results 803a-803k). For example, some map matchers 109 can generate extra sets of results by using different input parameters for their evaluation (such as search radius, heading tolerance, etc.).

These results can be plotted in various ways—linear graph, bar graph and scatter plots. Generally, there is no single way in a graph that can show all the possibilities of the quality results for all the map matchers 109 and for all the sensors data. But, by careful review of these results one by one, it was possible to understand the strength and weakness of each map matcher 109. What this example evaluation, however, can show is the understanding of the map matchers 109 strength and weakness in the quality for road types, sensor types, overall aggregate in each case, etc.

An example of ranking the map matchers 109 in decreasing order of quality is shown the graph of the user interface 801 of FIG. 8. The corresponding results 803a-803b (e.g., including sub-sampled results) of the various map matchers 109 are indicated in the x-axis and the quality as the average accuracy from the full and sub-sampled datasets collected over the designated period (e.g., 11 days of driving) are shown in y-axis. In this example, the each result 803a-803k indicated in the y-axis represents the corresponding map matcher 109 and input parameters used to generate the result. The vertical bar in each shows the quality variation expressed by standard error. The overall quality of different map matchers 109 and their input parameters can be determined from the graph of the user interface 801.

Returning to FIG. 1, as shown, the system 100 includes the MME platform 113 with connectivity or access over a communication network 121 to a geographic database 107 which stores digital map data against which probe trajectories can be map matched according to the embodiments described herein. In one embodiment, the MME platform 113 also has connectivity over the communication network 121 to the services platform 117 that provides one or more services 119 (e.g., services that use or generate stay point data). By way of example, the services 119 may be third party services and include mapping services, navigation services, travel planning services, notification services, social networking services, content (e.g., audio, video, images, etc.) provisioning services, application services, storage services, contextual information determination services, location based services, information based services (e.g., weather, news, etc.), etc. In one embodiment, the services 119 uses the output of the MME platform 113 (e.g., map matching quality, rankings, etc.) for presentation of user interfaces on client devices.

In one embodiment, the MME platform 113 may be a platform with multiple interconnected components. The MME platform 113 may include multiple servers, intelligent networking devices, computing devices, components and corresponding software for providing parametric representations of lane lines. In addition, it is noted that the MME platform 113 may be a separate entity of the system 100, a part of the one or more services 119, or a part of the services platform 117.

In one embodiment, content providers 123a-123m (collectively referred to as content providers 123) may provide content or data (e.g., including geographic data, road link data, etc.) to the geographic database 107, the services platform 117, the services 119, the UE 103, the vehicle 101, and/or an application 125 executing on the UE 103. The content provided may be any type of content, such as map content, textual content, audio content, video content, image content, etc. In one embodiment, the content providers 123 may provide content that may aid in the determining map matching quality using binary classification. In one embodiment, the content providers 123 may also store content associated with the geographic database 107, MME platform 113, services platform 117, services 119, UE 103, and/or vehicle 101. In another embodiment, the content providers 123 may manage access to a central repository of data, and offer a consistent, standard interface to data, such as a repository of the geographic database 107.

In one embodiment, the UE 103 and/or vehicle 101 may execute a software application 125 to capture probe trajectory data for determining map matching quality using binary classification according the embodiments described herein. By way of example, the application 125 may also be any type of application that is executable on the UE 103 and/or vehicle 101, such as autonomous driving applications, mapping applications, location-based service applications, navigation applications, content provisioning services, camera/imaging application, media player applications, social networking applications, calendar applications, and the like. In one embodiment, the application 125 may act as a client for the MME platform 113 and perform one or more functions associated with determining map matching quality using binary classification alone or in combination with the MME platform 113.

By way of example, the UE 103 is any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UE 103 can support any type of interface to the user (such as “wearable” circuitry, etc.). In one embodiment, the UE 103 may be associated with the vehicle 101 or be a component part of the vehicle 101.

In one embodiment, each vehicle 101 and/or UE 103 is assigned a unique probe identifier (probe ID) for use in reporting or transmitting probe data collected by the vehicle 101 and UE 103. The vehicle 101 and UE 103, for instance, are part of a probe-based system for collecting probe data in a road network. In one embodiment, each vehicle 101 and/or UE 103 is configured to report probe data as probe points, which are individual data records collected at a point in time that records telemetry data for that point in time. The probe points can be reported from the vehicle 101 and/or UEs 103 in real-time, in batches, continuously, or at any other frequency requested by the system 100 over, for instance, the communication network 121 for processing by the MME platform 113 (e.g., for use a ground truth trajectory data).

In one embodiment, a probe point can include attributes such as: probe ID, longitude, latitude, speed, and/or time. The list of attributes is provided by way of illustration and not limitation. Accordingly, it is contemplated that any combination of these attributes or other attributes may be recorded as a probe point (e.g., such as those previously discussed above). The probe points can be arranged by probe ID and time to construct probe trajectories for each probe ID. In one embodiment, the UE 103 and/or vehicle 101 are configured with various sensors for generating or collecting probe data (e.g., for processing by the MME platform 113), related geographic data, etc. In one embodiment, the sensed data represent sensor data associated with a geographic location or coordinates at which the sensor data was collected. By way of example, the sensors may include a global positioning sensor for gathering location data (e.g., GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture ground control point imagery, etc. for analysis), an audio recorder for gathering audio data, velocity sensors mounted on steering wheels of the vehicles, switch sensors for determining whether one or more vehicle switches are engaged, and the like.

Other examples of sensors of the UE 103 and/or vehicle 101 may include light sensors, orientation sensors augmented with height sensors and acceleration sensor (e.g., an accelerometer can measure acceleration and can be used to determine orientation of the vehicle), tilt sensors to detect the degree of incline or decline of the vehicle along a path of travel, moisture sensors, pressure sensors, etc. In a further example embodiment, sensors about the perimeter of the UE 103 and/or vehicle 101 may detect the relative distance of the vehicle from a lane or roadway, the presence of other vehicles, pedestrians, traffic lights, potholes and any other objects, or a combination thereof. In one scenario, the sensors may detect weather data, traffic information, or a combination thereof. In one embodiment, the UE 103 and/or vehicle 101 may include GPS or other satellite-based receivers to obtain geographic coordinates from satellites for determining current location and time. Further, the location can be determined by visual odometry, triangulation systems such as A-GPS, Cell of Origin, or other location extrapolation technologies. In yet another embodiment, the sensors can determine the status of various control elements of the car, such as activation of wipers, use of a brake pedal, use of an acceleration pedal, angle of the steering wheel, activation of hazard lights, activation of head lights, etc.

In one embodiment, the communication network 121 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the MME platform 113, services platform 117, services 119, UE 103, vehicle 101, and/or content providers 123 communicate with each other and other components of the system 100 using well known, new or still developing protocols. In this context, a protocol includes a set of rules defining how the network nodes within the communication network 121 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

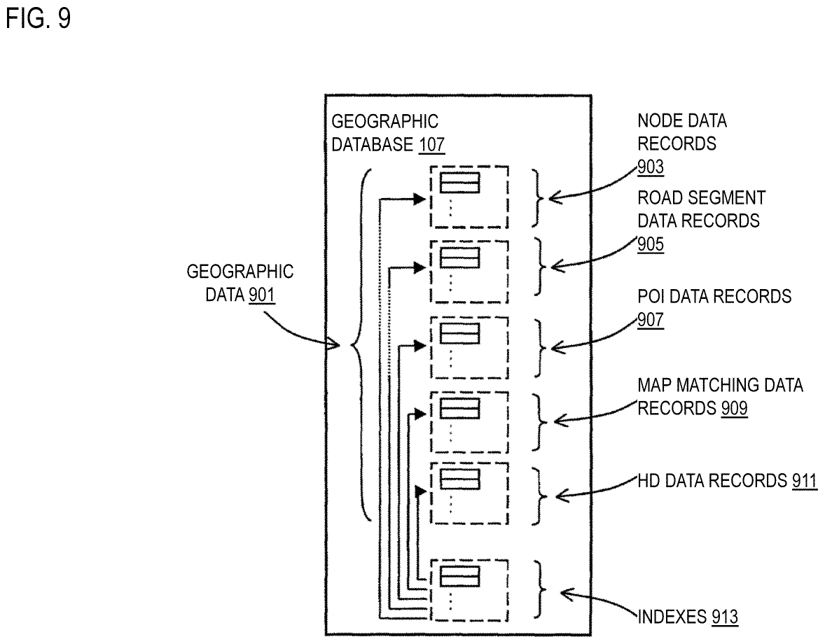

FIG. 9 is a diagram of a geographic database, according to one embodiment. In one embodiment, the geographic database 107 includes geographic data 901 used for (or configured to be compiled to be used for) mapping and/or navigation-related services, such as for video odometry based on the mapped features (e.g., lane lines, road markings, signs, etc.). In one embodiment, the geographic database 107 includes high resolution or high definition (HD) mapping data that provide centimeter-level or better accuracy of map features. For example, the geographic database 107 can be based on Light Detection and Ranging (LiDAR) or equivalent technology to collect billions of 3D points and model road surfaces and other map features down to the number lanes and their widths. In one embodiment, the HD mapping data (e.g., HD data records 911) capture and store details such as the slope and curvature of the road, lane markings, roadside objects such as sign posts, including what the signage denotes. By way of example, the HD mapping data enable highly automated vehicles to precisely localize themselves on the road.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 107.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 107 follows certain conventions. For example, links do not cross themselves and do not cross each other except at a node. Also, there are no duplicated shape points, nodes, or links. Two links that connect each other have a common node. In the geographic database 107, overlapping geographic features are represented by overlapping polygons. When polygons overlap, the boundary of one polygon crosses the boundary of the other polygon. In the geographic database 107, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 107 includes node data records 903, road segment or link data records 905, POI data records 907, map matching data records 909, HD mapping data records 911, and indexes 913, for example. More, fewer or different data records can be provided. In one embodiment, additional data records (not shown) can include cartographic (“cartel”) data records, routing data, and maneuver data. In one embodiment, the indexes 913 may improve the speed of data retrieval operations in the geographic database 107. In one embodiment, the indexes 913 may be used to quickly locate data without having to search every row in the geographic database 107 every time it is accessed. For example, in one embodiment, the indexes 913 can be a spatial index of the polygon points associated with stored feature polygons.

In exemplary embodiments, the road segment data records 905 are links or segments representing roads, streets, or paths, as can be used in the calculated route or recorded route information for determination of one or more personalized routes. The node data records 903 are end points corresponding to the respective links or segments of the road segment data records 905. The road link data records 905 and the node data records 903 represent a road network, such as used by vehicles, cars, and/or other entities. Alternatively, the geographic database 107 can contain path segment and node data records or other data that represent pedestrian paths or areas in addition to or instead of the vehicle road record data, for example.

The road/link segments and nodes can be associated with attributes, such as functional class, a road elevation, a speed category, a presence or absence of road features, geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 107 can include data about the POIs and their respective locations in the POI data records 907. The geographic database 107 can also include data about places, such as cities, towns, or other communities, and other geographic features, such as bodies of water, mountain ranges, etc. Such place or feature data can be part of the POI data records 907 or can be associated with POIs or POI data records 907 (such as a data point used for displaying or representing a position of a city).

In one embodiment, the geographic database 107 can also include map matching data records 909 for storing the ground truth trajectory data, appended map-matched output files, map matching quality results, related data for providing corresponding user interfaces, as well as other related data used or generated according to the various embodiments described herein. In one embodiment, the map matching data records 909 can be published or otherwise presented to provide map matching quality results, map matcher rankings, ground truth verifications, etc. to end users. By way of example, the map matching data records 909 can be associated with one or more of the node records 903, road segment records 905, and/or POI data records 907. In this way, the stay point data records 909 can also be associated with or used to classify the characteristics or metadata of the corresponding records 903, 905, and/or 907.

In one embodiment, as discussed above, the HD mapping data records 911 model road surfaces and other map features to centimeter-level or better accuracy. The HD mapping data records 911 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the HD mapping data records 911 are divided into spatial partitions of varying sizes to provide HD mapping data to vehicles 101 and other end user devices with near real-time speed without overloading the available resources of the vehicles 101 and/or devices (e.g., computational, memory, bandwidth, etc. resources).

In one embodiment, the HD mapping data records 911 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 911.

In one embodiment, the HD mapping data records 911 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 107 can be maintained by the content provider 119 in association with the services platform 117 (e.g., a map developer). The map developer can collect geographic data to generate and enhance the geographic database 107. There can be different ways used by the map developer to collect data. These ways can include obtaining data from other sources, such as municipalities or respective geographic authorities. In addition, the map developer can employ field personnel to travel by vehicle (e.g., vehicle 101 and/or UE 103) along roads throughout the geographic region to observe features and/or record information about them, for example. Also, remote sensing, such as aerial or satellite photography, can be used.

The geographic database 107 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 101 or UE 103, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for determining map matching quality using binary classification may be advantageously implemented via software, hardware, firmware or a combination of software and/or firmware and/or hardware. For example, the processes described herein, including for providing user interface navigation information associated with the availability of services, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

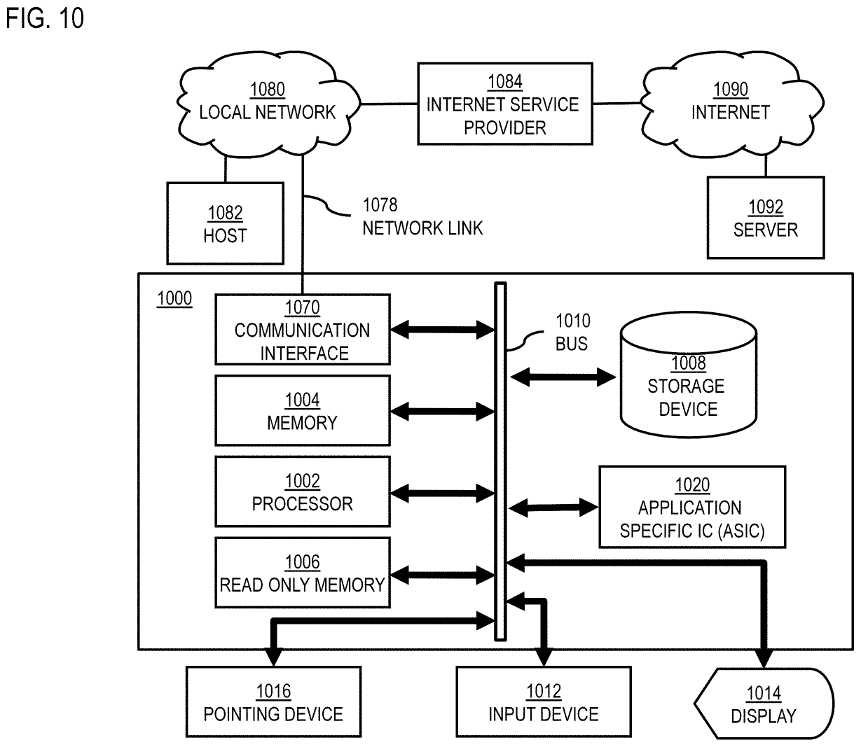

FIG. 10 illustrates a computer system 1000 upon which an embodiment of the invention may be implemented. Although computer system 1000 is depicted with respect to a particular device or equipment, it is contemplated that other devices or equipment (e.g., network elements, servers, etc.) within FIG. 10 can deploy the illustrated hardware and components of system 1000. Computer system 1000 is programmed (e.g., via computer program code or instructions) to determine map matching quality using binary classification as described herein and includes a communication mechanism such as a bus 1010 for passing information between other internal and external components of the computer system 1000. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1000, or a portion thereof, constitutes a means for performing one or more steps of determining map matching quality using binary classification.

A bus 1010 includes one or more parallel conductors of information so that information is transferred quickly among devices coupled to the bus 1010. One or more processors 1002 for processing information are coupled with the bus 1010.

A processor (or multiple processors) 1002 performs a set of operations on information as specified by computer program code related to determining map matching quality using binary classification. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1010 and placing information on the bus 1010. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1002, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1000 also includes a memory 1004 coupled to bus 1010. The memory 1004, such as a random access memory (RAM) or other dynamic storage device, stores information including processor instructions for determining map matching quality using binary classification. Dynamic memory allows information stored therein to be changed by the computer system 1000. RAM allows a unit of information stored at a location called a memory address to be stored and retrieved independently of information at neighboring addresses. The memory 1004 is also used by the processor 1002 to store temporary values during execution of processor instructions. The computer system 1000 also includes a read only memory (ROM) 1006 or other static storage device coupled to the bus 1010 for storing static information, including instructions, that is not changed by the computer system 1000. Some memory is composed of volatile storage that loses the information stored thereon when power is lost. Also coupled to bus 1010 is a non-volatile (persistent) storage device 1008, such as a magnetic disk, optical disk or flash card, for storing information, including instructions, that persists even when the computer system 1000 is turned off or otherwise loses power.

Information, including instructions for determining map matching quality using binary classification, is provided to the bus 1010 for use by the processor from an external input device 1012, such as a keyboard containing alphanumeric keys operated by a human user, or a sensor. A sensor detects conditions in its vicinity and transforms those detections into physical expression compatible with the measurable phenomenon used to represent information in computer system 1000. Other external devices coupled to bus 1010, used primarily for interacting with humans, include a display device 1014, such as a cathode ray tube (CRT) or a liquid crystal display (LCD), or plasma screen or printer for presenting text or images, and a pointing device 1016, such as a mouse or a trackball or cursor direction keys, or motion sensor, for controlling a position of a small cursor image presented on the display 1014 and issuing commands associated with graphical elements presented on the display 1014. In some embodiments, for example, in embodiments in which the computer system 1000 performs all functions automatically without human input, one or more of external input device 1012, display device 1014 and pointing device 1016 is omitted.

In the illustrated embodiment, special purpose hardware, such as an application specific integrated circuit (ASIC) 1020, is coupled to bus 1010. The special purpose hardware is configured to perform operations not performed by processor 1002 quickly enough for special purposes. Examples of application specific ICs include graphics accelerator cards for generating images for display 1014, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1000 also includes one or more instances of a communications interface 1070 coupled to bus 1010. Communication interface 1070 provides a one-way or two-way communication coupling to a variety of external devices that operate with their own processors, such as printers, scanners and external disks. In general the coupling is with a network link 1078 that is connected to a local network 1080 to which a variety of external devices with their own processors are connected. For example, communication interface 1070 may be a parallel port or a serial port or a universal serial bus (USB) port on a personal computer. In some embodiments, communications interface 1070 is an integrated services digital network (ISDN) card or a digital subscriber line (DSL) card or a telephone modem that provides an information communication connection to a corresponding type of telephone line. In some embodiments, a communication interface 1070 is a cable modem that converts signals on bus 1010 into signals for a communication connection over a coaxial cable or into optical signals for a communication connection over a fiber optic cable. As another example, communications interface 1070 may be a local area network (LAN) card to provide a data communication connection to a compatible LAN, such as Ethernet. Wireless links may also be implemented. For wireless links, the communications interface 1070 sends or receives or both sends and receives electrical, acoustic or electromagnetic signals, including infrared and optical signals, that carry information streams, such as digital data. For example, in wireless handheld devices, such as mobile telephones like cell phones, the communications interface 1070 includes a radio band electromagnetic transmitter and receiver called a radio transceiver. In certain embodiments, the communications interface 1070 enables connection to the communication network 121 for determining map matching quality using binary classification.

The term “computer-readable medium” as used herein refers to any medium that participates in providing information to processor 1002, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1008. Volatile media include, for example, dynamic memory 1004. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1020.

Network link 1078 typically provides information communication using transmission media through one or more networks to other devices that use or process the information. For example, network link 1078 may provide a connection through local network 1080 to a host computer 1082 or to equipment 1084 operated by an Internet Service Provider (ISP). ISP equipment 1084 in turn provides data communication services through the public, world-wide packet-switching communication network of networks now commonly referred to as the Internet 1090.

A computer called a server host 1092 connected to the Internet hosts a process that provides a service in response to information received over the Internet. For example, server host 1092 hosts a process that provides information representing video data for presentation at display 1014. It is contemplated that the components of system 1000 can be deployed in various configurations within other computer systems, e.g., host 1082 and server 1092.

At least some embodiments of the invention are related to the use of computer system 1000 for implementing some or all of the techniques described herein. According to one embodiment of the invention, those techniques are performed by computer system 1000 in response to processor 1002 executing one or more sequences of one or more processor instructions contained in memory 1004. Such instructions, also called computer instructions, software and program code, may be read into memory 1004 from another computer-readable medium such as storage device 1008 or network link 1078. Execution of the sequences of instructions contained in memory 1004 causes processor 1002 to perform one or more of the method steps described herein. In alternative embodiments, hardware, such as ASIC 1020, may be used in place of or in combination with software to implement the invention. Thus, embodiments of the invention are not limited to any specific combination of hardware and software, unless otherwise explicitly stated herein.

The signals transmitted over network link 1078 and other networks through communications interface 1070, carry information to and from computer system 1000. Computer system 1000 can send and receive information, including program code, through the networks 1080, 1090 among others, through network link 1078 and communications interface 1070. In an example using the Internet 1090, a server host 1092 transmits program code for a particular application, requested by a message sent from computer 1000, through Internet 1090, ISP equipment 1084, local network 1080 and communications interface 1070. The received code may be executed by processor 1002 as it is received, or may be stored in memory 1004 or in storage device 1008 or other non-volatile storage for later execution, or both. In this manner, computer system 1000 may obtain application program code in the form of signals on a carrier wave.

Various forms of computer readable media may be involved in carrying one or more sequence of instructions or data or both to processor 1002 for execution. For example, instructions and data may initially be carried on a magnetic disk of a remote computer such as host 1082. The remote computer loads the instructions and data into its dynamic memory and sends the instructions and data over a telephone line using a modem. A modem local to the computer system 1000 receives the instructions and data on a telephone line and uses an infra-red transmitter to convert the instructions and data to a signal on an infra-red carrier wave serving as the network link 1078. An infrared detector serving as communications interface 1070 receives the instructions and data carried in the infrared signal and places information representing the instructions and data onto bus 1010. Bus 1010 carries the information to memory 1004 from which processor 1002 retrieves and executes the instructions using some of the data sent with the instructions. The instructions and data received in memory 1004 may optionally be stored on storage device 1008, either before or after execution by the processor 1002.

FIG. 11 illustrates a chip set or chip 1100 upon which an embodiment of the invention may be implemented. Chip set 1100 is programmed to determine map matching quality using binary classification as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1100 can be implemented in a single chip. It is further contemplated that in certain embodiments the chip set or chip 1100 can be implemented as a single “system on a chip.” It is further contemplated that in certain embodiments a separate ASIC would not be used, for example, and that all relevant functions as disclosed herein would be performed by a processor or processors. Chip set or chip 1100, or a portion thereof, constitutes a means for performing one or more steps of providing user interface navigation information associated with the availability of services. Chip set or chip 1100, or a portion thereof, constitutes a means for performing one or more steps of determining map matching quality using binary classification.

In one embodiment, the chip set or chip 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1100 includes merely one or more processors and some software and/or firmware supporting and/or relating to and/or for the one or more processors.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to determine map matching quality using binary classification. The memory 1105 also stores the data associated with or generated by the execution of the inventive steps.

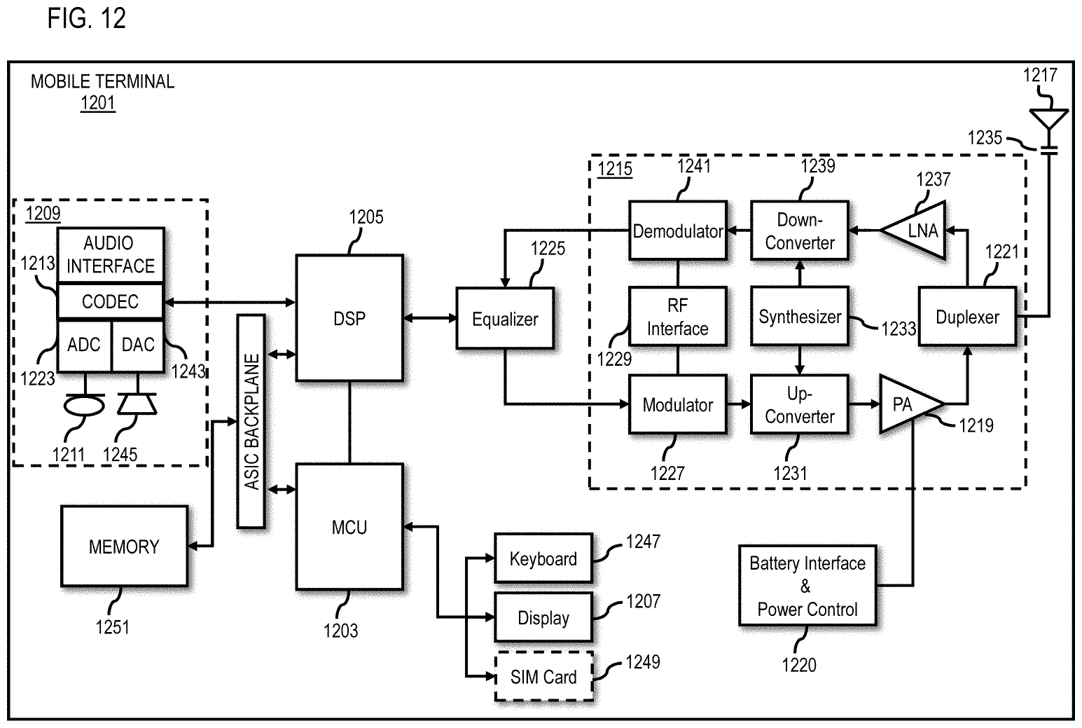

FIG. 12 is a diagram of exemplary components of a mobile terminal 1201 (e.g., handset such as the UE 103, vehicle 101, or component thereof) for communications, which is capable of operating in the system of FIG. 1, according to one embodiment. In some embodiments, the mobile terminal 1201, or a portion thereof, constitutes a means for performing one or more steps of determining map matching quality using binary classification. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1203, a Digital Signal Processor (DSP) 1205, and a receiver/transmitter unit including a microphone gain control unit and a speaker gain control unit. A main display unit 1207 provides a display to the user in support of various applications and mobile terminal functions that perform or support the steps of determining map matching quality using binary classification. The display 1207 includes display circuitry configured to display at least a portion of a user interface of the mobile terminal (e.g., mobile telephone). Additionally, the display 1207 and display circuitry are configured to facilitate user control of at least some functions of the mobile terminal. An audio function circuitry 1209 includes a microphone 1211 and microphone amplifier that amplifies the speech signal output from the microphone 1211. The amplified speech signal output from the microphone 1211 is fed to a coder/decoder (CODEC) 1213.

A radio section 1215 amplifies power and converts frequency in order to communicate with a base station, which is included in a mobile communication system, via antenna 1217. The power amplifier (PA) 1219 and the transmitter/modulation circuitry are operationally responsive to the MCU 1203, with an output from the PA 1219 coupled to the duplexer 1221 or circulator or antenna switch, as known in the art. The PA 1219 also couples to a battery interface and power control unit 1220.

In use, a user of mobile terminal 1201 speaks into the microphone 1211 and his or her voice along with any detected background noise is converted into an analog voltage. The analog voltage is then converted into a digital signal through the Analog to Digital Converter (ADC) 1223. The control unit 1203 routes the digital signal into the DSP 1205 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a PA 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203—which can be implemented as a Central Processing Unit (CPU) (not shown).

The MCU 1203 receives various signals including input signals from the keyboard 1247. The keyboard 1247 and/or the MCU 1203 in combination with other user input components (e.g., the microphone 1211) comprise a user interface circuitry for managing user input. The MCU 1203 runs a user interface software to facilitate user control of at least some functions of the mobile terminal 1201 to determine map matching quality using binary classification. The MCU 1203 also delivers a display command and a switch command to the display 1207 and to the speech output switching controller, respectively. Further, the MCU 1203 exchanges information with the DSP 1205 and can access an optionally incorporated SIM card 1249 and a memory 1251. In addition, the MCU 1203 executes various control functions required of the terminal. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile terminal 1201.

The CODEC 1213 includes the ADC 1223 and DAC 1243. The memory 1251 stores various data including call incoming tone data and is capable of storing other data including music data received via, e.g., the global Internet. The software module could reside in RAM memory, flash memory, registers, or any other form of writable storage medium known in the art. The memory device 1251 may be, but not limited to, a single memory, CD, DVD, ROM, RAM, EEPROM, optical storage, or any other non-volatile storage medium capable of storing digital data.

An optionally incorporated SIM card 1249 carries, for instance, important information, such as the cellular phone number, the carrier supplying service, subscription details, and security information. The SIM card 1249 serves primarily to identify the mobile terminal 1201 on a radio network. The card 1249 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A computer-implemented method for determining map matching quality comprising:
processing probe trajectory data using a map matcher to generate a map-matched output;
comparing the map-matched output for a probe point of the probe trajectory data against ground truth map-matched data for the probe trajectory data to classify the probe point according to one or more binary classifications, wherein the one or more binary classifications indicate a correctness or an incorrectness of matching with respect to the ground truth map-matched data; and
computing the map matching quality of the map matcher based on the one or more binary classifications.

2. The method of claim 1, wherein the one or more binary classifications include at least one of:
a matched corrected classification indicating that the probe point is matched by the map matcher to a same road link as indicated in the ground truth map-matched data;
a first matched incorrect classification indicating that the probe point is matched by the map matcher a different road link than indicated in the ground truth map-matched data;
a second matched incorrect classification indicating that probe point is matched by the map matcher but is not matched in the ground truth map-matched output;
a combined matched incorrect classification that combines the first matched incorrect classification and the second matched incorrect classification;
an unmatched correct classification indicating that probe point is unmatched by the map matcher and in the ground truth map-matched data;
an unmatched incorrect classification indicating that the probe point is unmatched by the map matcher but is matched in the ground truth map-matched data;
a matched unknown classification indicating that the probe point is matched by the map matcher but is unknown in the ground truth map-matched data; and
an unmatched unknown classification indicating that the probe point is unmatched by the map matcher but is unknown in the ground truth map-matched data.

3. The method of claim 1, further comprising:
aggregating the one or more binary classifications across a plurality of probe points of the probe trajectory in the map-matched output; and
calculating one or more accuracy parameters based on the aggregated one or more binary classifications.

4. The method of claim 3, wherein one or more accuracy parameters an accuracy parameter, a precision parameter, a recall parameter, an F1 score, or a combination thereof.

5. The method of claim 1, further comprising:
creating a subset of the probe trajectory data based on a map attribute, a probe vehicle attribute, a location sensor attribute, or a combination thereof,
wherein the map-matched output is generated by the map matcher using the subset of the probe trajectory data to determine map matching quality with respect to the map attribute, the probe vehicle attribute, the location sensor attribute, or a combination thereof.

6. The method of claim 1, further comprising:
resampling the probe trajectory data to reduce a number of probe points in the probe trajectory data,
wherein the map-matched output is generated by the map matcher using the resampled probe trajectory data.

7. The method of claim 6, wherein the resampling is the probe trajectory is based on a time interval.

8. The method of claim 6, further comprising:
calculating an average, a standard error, or a combination thereof of the map matching quality based on the resample probe trajectory data.

9. The method of claim 1, further comprising:
determining respective map matching quality for a plurality of map matchers based on the one or more binary classifications;
ranking the plurality of map matchers based on the respective map matching quality; and
providing data for presenting a user interface including a representation of the ranking of the plurality of map matchers.

10. The method of claim 1, wherein the probe trajectory data is ground truth probe trajectory data collected from a plurality of sensors cover a plurality of road types.

11. An apparatus for determining map matching quality comprising:
at least one processor; and
at least one memory including computer program code for one or more programs,
the at least one memory and the computer program code configured to, with the at least one processor, cause the apparatus to perform at least the following,
collect probe trajectory data from a plurality of sensors covering a plurality of road types; and
use a reference map matcher to generate a candidate map-matched output, wherein the candidate map-matched output is verified to create ground truth map-matched data for the probe trajectory data,
wherein the map matching quality of a map matcher is determined by using the map matcher to generate a map-matched output from the probe trajectory data and computing the map matching quality based on one or more binary classifications of a comparison of the map-matched output and the ground truth map-matched data.

12. The apparatus of claim 11, wherein the probe trajectory is collected simultaneously from the plurality of sources.

13. The apparatus of claim 11, wherein the apparatus is further caused to:
synchronize the probe trajectory from in the plurality of sensors in time before generating the map-matched output.

14. The apparatus of claim 11, wherein the one or more binary classifications include at least one of:
a matched corrected classification indicating that the probe point is matched by the map matcher to a same road link as indicated in the ground truth map-matched data;
a first matched incorrect classification indicating that the probe point is matched by the map matcher a different road link than indicated in the ground truth map-matched data;
a second matched incorrect classification indicating that probe point is matched by the map matcher but is not matched in the ground truth map-matched output;
a combined matched incorrect classification that combines the first matched incorrect classification and the second matched incorrect classification;
an unmatched correct classification indicating that probe point is unmatched by the map matcher and in the ground truth map-matched data;
an unmatched incorrect classification indicating that the probe point is unmatched by the map matcher but is matched in the ground truth map-matched data;
a matched unknown classification indicating that the probe point is matched by the map matcher but is unknown in the ground truth map-matched data; and
an unmatched unknown classification indicating that the probe point is unmatched by the map matcher but is unknown in the ground truth map-matched data.

15. The apparatus of claim 13, wherein the apparatus is further caused to:
aggregate the one or more binary classifications across a plurality of probe points of the probe trajectory in the map-matched output; and
calculate one or more accuracy parameters based on the aggregated one or more binary classifications.

16. A non-transitory computer-readable storage medium for determining map matching quality, carrying one or more sequences of one or more instructions which, when executed by one or more processors, cause an apparatus to perform:
processing probe trajectory data using a map matcher to generate a map-matched output;
comparing the map-matched output for a probe point of the probe trajectory data against ground truth map-matched data for the probe trajectory data to classify the probe point according to one or more binary classifications, wherein the one or more binary classifications indicate a correctness or an incorrectness of matching with respect to the ground truth map-matched data; and
computing the map matching quality of the map matcher based on the one or more binary classifications.

17. The non-transitory computer-readable storage medium of claim 16, wherein the one or more binary classifications include at least one of:
a matched corrected classification indicating that the probe point is matched by the map matcher to a same road link as indicated in the ground truth map-matched data;
a first matched incorrect classification indicating that the probe point is matched by the map matcher a different road link than indicated in the ground truth map-matched data;
a second matched incorrect classification indicating that probe point is matched by the map matcher but is not matched in the ground truth map-matched output;
a combined matched incorrect classification that combines the first matched incorrect classification and the second matched incorrect classification;
an unmatched correct classification indicating that probe point is unmatched by the map matcher and in the ground truth map-matched data;
an unmatched incorrect classification indicating that the probe point is unmatched by the map matcher but is matched in the ground truth map-matched data;
a matched unknown classification indicating that the probe point is matched by the map matcher but is unknown in the ground truth map-matched data; and
an unmatched unknown classification indicating that the probe point is unmatched by the map matcher but is unknown in the ground truth map-matched data.

18. The non-transitory computer-readable storage medium of claim 17, wherein the apparatus is caused to further perform:
aggregating the one or more binary classifications across a plurality of probe points of the probe trajectory in the map-matched output; and
calculating one or more accuracy parameters based on the aggregated one or more binary classifications.

19. The non-transitory computer-readable storage medium of claim 18, wherein one or more accuracy parameters an accuracy parameter, a precision parameter, a recall parameter, an F1 score, or a combination thereof.

20. The non-transitory computer-readable storage medium of claim 16, wherein the apparatus is caused to further perform:
creating a subset of the probe trajectory data based on a map attribute, a probe vehicle attribute, a location sensor attribute, or a combination thereof,
wherein the map-matched output is generated by the map matcher using the subset of the probe trajectory data to determine map matching quality with respect to the map attribute, the probe vehicle attribute, the location sensor attribute, or a combination thereof.
